(19) United States
(12) Patent Application Publication
(10) Pub. No.: US 2026/0058768 A1
(43) Pub. Date: Feb. 26, 2026

(54) CAPABILITY SIGNALING FOR MACHINE LEARNING BASED ENCODING OF UPLINK CONTROL INFORMATION

(71) Applicant: Telefonaktiebolaget LM Ericsson (publ), Stockholm (SE)

(72) Inventors: Dandan HAO, Beijing (CN); Mattias FRENNE, UPPSALA (SE)

(73) Assignee: Telefonaktiebolaget LM Ericsson (publ), Stockholm (SE)

(21) Appl. No.: 19/099,475

(22) PCT Filed: Jul. 25, 2023
(86) PCT No.: PCT/EP2023/070590

§ 371 Date: Jan. 29, 2025

(30) Foreign Application Priority Data
Aug. 10, 2022 (WO) PCT/CN2022/111432

(51) Int. Cl. H04L 5/00; H04B 7/06; H04L 41/16

(52) U.S. Cl. CPC H04L 5/0044; H04B 7/0626; H04B 7/06952; H04L 41/16

(57) ABSTRACT

A wireless device (10) receives control data provided by a node (100) of the wireless communication network. The control data indicates a set of one or more supported machine-learning models for encoding and decoding of uplink control signaling from the wireless device (10) to the node (100). The wireless device (10) selects one or more of the machine-learning models from the set. Based on at least one of the one or more selected machine-learning models, the wireless device (10) encodes uplink control signaling from the wireless device (10) to the node (100).

### TECHNICAL FIELD

The present disclosure relates to methods for management of a network service and to corresponding devices, systems, and computer programs.

### BACKGROUND

In wireless communication networks, e.g., as specified by 3GPP (3rd Generation Partnership Project), efficient encoding of wireless transmissions is an important factor. For example, the 5th generation (5G) technology specified by 3GPP, also denoted as NR (New Radio) technology, uses OFDM (Orthogonal Frequency Division Multiplexing) with configurable bandwidths and subcarrier spacing to efficiently support a diverse set of use cases and deployment scenarios. With respect to the LTE (Long Term Evolution) technology specified by 3GPP, the NR technology provides improvements concerning deployment flexibility, achievable user throughputs, latency and reliability. The NR technology also provides enhanced support for spatial multiplexing, in particular spatial sharing of time-frequency resources across users, commonly referred to as Multi-User MIMO (MU-MIMO).

FIG. 1 schematically illustrates principles of MU-MIMO transmission: A multi-antenna base station with N_{TX} antenna ports simultaneously, i.e., on the same OFDM time-frequency resources, transmits information to several UEs. A sequence S⁽¹⁾ is transmitted to UE(1), a sequence S⁽¹⁾ is transmitted to UE(2), etc. Before modulation and transmission, precoding

$${W}_{V}^{( j )}$$

is applied to each sequence S⁽ⁱ⁾ to spatially separate the transmissions and mitigate multiplexing interference.

Each UE demodulates its received signal and combines received antenna signals in order to obtain an estimate Ŝ⁽ⁱ⁾ of the transmitted sequence. This estimate Ŝ⁽ⁱ⁾ can be expressed as

$${\hat{S}}^{( i )} = {\underbrace{{W}_{U}^{( i )} {H}^{( i )} {W}_{V}^{( i )}}}_{\approx I} {S}^{( i )} + {W}_{U}^{( i )} {H}^{( i )} {\sum }_{j , j \neq i} {W}_{V}^{( j )} {S}^{( j )} , \qquad ( 1 )$$

The second additive term in (1) represents the spatial multiplexin interference seen by UE(i). The goal for the base station is to construct the set of precoders

$$\{ {W}_{V}^{( j )} \}$$

in such a way that the norm

$$‖ {H}^{( i )} {W}_{V}^{( i )} ‖$$

is large whereas the norm

$$‖ {H}^{( j )} {W}_{V}^{( i )} ‖ ,$$

j≠i is small. In other words, the precoder

$${W}_{V}^{( i )}$$

shall provide a high correlation with the channel H⁽ⁱ⁾ observed by UE(i) whereas it provides a low correlation with the channels observed by other UEs. For constructing the precoders for efficient MU-MIMO transmissions, the base station typically needs to acquire detailed knowledge of the channels H(i).

In deployments where channel reciprocity holds, detailed channel knowledge can be acquired from uplink sounding reference signals (SRS) that are transmitted periodically, or on demand, by active UEs. Based on these SRS, the base station can directly estimate the uplink channel and, therefore, the downlink channel H(i).

However, if channel reciprocity does not hold, active UEs need to feedback channel details to the base station. Such feedback information is also referred to as Channel State Information (CSI). In LTE and NR, the feedback of CSI is typically based on periodically transmitted CSI reference signals (CSI-RS) periodically transmitted by the base station. From the CSI-RS, the UE can estimate the downlink channel and then report corresponding CSI to the base station. The CSI is typically reported over an uplink control channel or over an uplink data channel. The base station then uses the reported CSI to select suitable precoders for downlink MU-MIMO transmissions.

The CSI feedback mechanism targeting MU-MIMO operations in NR is referred to as CSI Type II. Type II CSI is based on specifying sets of Discrete Fourier Transform (DFT) basis functions, sometimes also denoted as “grid of beams” from which the UE selects those that best match its channel conditions, similar to a classical codebook PMI (Precoding Matrix Indicator).

In addition, the UE also reports how these beams should be combined in terms of relative amplitude scaling and co-phasing. The number of beams the UE reports is configurable and may be 2 or 4 typically. Reporting more beams increases the CSI resolution feedback, but comes at the cost of additional uplink signaling overhead.

FIG. 2 further illustrates CSI type II. As illustrated, the selection of DFT beam vectors bₙ, and the determination of the relative amplitudes αₙ corresponding to the selected DFT beam vectors bₙ, are accomplished from a wideband perspective whereas the co-phasing, i.e., determination of the corresponding phase angles θₙ is accomplished per subband. Here, “wideband perspective” means that the selected DFT beam vectors are the same for all subcarriers used in the OFDM transmission, whereas “per subband” means that co-phasing parameters are determined over subsets of contiguous subcarriers. The co-phasing parameters are quantized such that e^{jθ}^{ₙ} is taken from either a QPSK or 8PSK signal constellation.

With k denoting a sub-band index, the precoder reported by the UE can be expressed as

$${W}_{V} [ k ] = {\sum }_{n} {b}_{n} {a}_{n} {e}^{j {θ}_{n} [ k ]} . \qquad ( 2 )$$

When the base station schedules multiple UEs spatially, it may select UEs that have reported different set of beams or beams that have weak correlations. The CSI type II thus represents a MIMO channel feedback mechanism where a UE reports a precoder hypothesis that trades off CSI resolution against uplink signaling overhead. In view of this situation, usage of CSI type II may be regarded as a suboptimal precoding approach for MU-MIMO that tries to balance uplink signaling overhead with MU-MIMO precoding performance.

Recently neural network based autoencoders (AEs) have shown promising results for compressing downlink MIMO channel estimates for uplink feedback. An AE is a type of artificial neural network (NN) that can be used to compress data in an unsupervised manner. That is, the AE works with only input data and no output labels are needed. These networks aim to reconstruct the input data at the output layer with high fidelity with respect to a given loss function.

FIG. 3 schematically illustrates a simple fully connected, or dense, AE architecture. Such AE architecture, the AE may be regarded as being divided into two parts: an encoder located at the UE, and a decoder located at the base station. The output of the encoder, which corresponds to the bottleneck layer of the NN, represents the code values that are to be signaled from the UE to the base station.

AEs can have different architectures. For example, AEs can be based on fully connected NNs, multi-dimensional convolution NNs, recurrent NNs, or any combination thereof. However, all AEs architectures possess the encoder-bottleneck-decoder structure illustrated in FIG. 3.

When using an AE, the size of the code to be signaled, in FIG. 3 denoted by Y, is typically much smaller than the size of the input data, in FIG. 3 denoted by X. The encoder part of an AE reduces the spatial dimensionality of the input features with increasing depth of the NN. The decoder part of the AE basically does the inverse, i.e., it gradually returns the compressed code to its original feature size. At the output layer, the AE reconstructs the original input data with some loss. In FIG. 3, the reconstructed data is denoted by \hat{X}.

The architecture of an AE is typically numerically optimized for the specific application, e.g., channel compression. This is accomplished via a process called hyperparameter tuning. Hardware limitations of the encoder and decoder also need to be considered when optimizing the AE's architecture.

The weights and biases of an AE (with a fixed architecture) may be optimized to improve the fidelity of the reconstructed data \hat{X}. For example, the weights and biases can be trained to minimize the mean squared error (MSE) of the reconstruction, i.e., to minimize (X− [symbol] Model training is typically done using some variant of stochastic gradient descent on a large data set. This data set should be representative of the actual data the AE will encounter during live operation.

The process of designing an AE, in particular hyperparameter tuning and model training, is typically expensive and consumes significant computation, memory, and power resources. Further, in order to achieve good performance, the encoder part and the decoder part of the AE may need to be trained jointly. This may cause a scalability problem, because the decoder part at the base station may need to support a high number of different encoder types from different vendors or of different versions. Similarly, the encoder part at the UE may need to support different decoder types at the base station. In addition, for a given chipset vendor on the UE side and base station side, there may be multiple releases of the same basic AE model, since the AE models are updated by training when more data becomes available. This further increases the number of different encoder models and decoder models that need to be handled when attempting to find matching encoder part and decoder part of an AE.

Accordingly, there is a need for efficiently controlling encoding and decoding of uplink control signaling by AEs or other machine-learning (ML) models.

### SUMMARY

According to an embodiment, a method of controlling wireless communication in a wireless communication network is provided. According to the method, a wireless device receives control data provided by a first node of the wireless communication network. The control data indicates a set of one or more supported ML models for encoding and decoding of uplink control signaling from the wireless device to the first node. The wireless device selects one or more of the ML models from the set. Based on at least one of the one or more selected ML models, the wireless device encodes uplink control signaling from the wireless device to the first node.

According to a further embodiment, a method of controlling wireless communication in a wireless communication network is provided. According to the method, a node of the wireless communication network provides control data to one or more wireless devices. The control data indicates a set of one or more supported ML models for encoding and decoding of uplink control signaling from the wireless device to the node. Using at least one ML model selected from the set, the node decodes uplink control signaling from at least one of the one or more wireless devices.

According to a further embodiment, a wireless device for operation in a wireless communication network is provided. The wireless device is configured to receive control data provided by a first node of the wireless communication network. The control data indicates a set of one or more supported ML models for encoding and decoding of uplink control signaling from the wireless device to the first node. Further, the wireless device is configured to select one or more of the ML models from the set. Further, the wireless device is configured to, based on at least one of the one or more selected ML models, encode uplink control signaling from the wireless device to the first node.

According to a further embodiment, a wireless device for operation in a wireless communication network is provided. The wireless device comprises at least one processor and a memory. The memory contains instructions executable by said at least one processor, whereby the wireless device is operative to receive control data provided by a first node of the wireless communication network. The control data indicates a set of one or more supported ML models for encoding and decoding of uplink control signaling from the wireless device to the first node. Further, the memory contains instructions executable by said at least one processor, whereby the wireless device is operative to select one or more of the ML models from the set. Further, the memory contains instructions executable by said at least one processor, whereby the wireless device is operative to, based on at least one of the one or more selected ML models, encode uplink control signaling from the wireless device to the first node.

According to a further embodiment, a node for a wireless communication network is provided. The node is configured to provide control data to one or more wireless devices. The control data indicates a set of one or more supported ML models for encoding and decoding of uplink control signaling from the wireless device to the node. Further, the node is configured to, using at least one ML model selected from the set, decode uplink control signaling from at least one of the one or more wireless devices.

According to a further embodiment, a node for a wireless communication network is provided. The node comprises at least one processor and a memory. The memory contains instructions executable by said at least one processor, whereby the node is operative to provide control data to one or more wireless devices. The control data indicates a set of one or more supported ML models for encoding and decoding of uplink control signaling from the wireless device to the node. Further, the memory contains instructions executable by said at least one processor, whereby the node is operative to, using at least one ML model selected from the set, decode uplink control signaling from at least one of the one or more wireless devices.

According to a further embodiment, a computer program or computer program product is provided, e.g., in the form of a non-transitory storage medium, which comprises program code to be executed by at least one processor of a wireless device for operation in a wireless communication network. Execution of the program code causes the wireless device to receive control data provided by a first node of the wireless communication network. The control data indicates a set of one or more supported ML models for encoding and decoding of uplink control signaling from the wireless device to the first node. Further, execution of the program code causes the wireless device to select one or more of the ML models from the set. Further, execution of the program code causes the wireless device to, based on at least one of the one or more selected ML models, the wireless device encodes uplink control signaling from the wireless device to the first node.

According to a further embodiment, a computer program or computer program product is provided, e.g., in the form of a non-transitory storage medium, which comprises program code to be executed by at least one processor of a node for a wireless communication network. Execution of the program code causes the node to provide control data to one or more wireless devices. The control data indicates a set of one or more supported ML models for encoding and decoding of uplink control signaling from the wireless device to the node. Further, execution of the program code causes the node to, using at least one ML model selected from the set, decode uplink control signaling from at least one of the one or more wireless devices.

Details of such embodiments and further embodiments will be apparent from the following detailed description of embodiments.

### BRIEF DESCRIPTION OF THE DRAWINGS

FIG. 1 schematically illustrates MU-MIMO operation in a wireless communication network.

FIG. 2 schematically illustrates CSI Type II feedback of the NR technology.

FIG. 3 schematically illustrates an AE architecture.

FIG. 4 schematically illustrates a wireless communication network according to an embodiment.

FIG. 5 schematically illustrates CSI reporting according to an embodiment.

FIG. 6 illustrates an example of processes according to an embodiment.

FIG. 7 illustrates a further example of processes according to an embodiment.

FIG. 8 shows a flowchart for schematically illustrating a method according to an embodiment.

FIG. 9 shows a flowchart for schematically illustrating a further method according to an embodiment.

FIG. 10 schematically illustrates structures of a wireless device according to an embodiment.

FIG. 11 schematically illustrates structures of a network node according to an embodiment.

FIG. 12 schematically illustrates interaction of a host and a wireless device according to an embodiment.

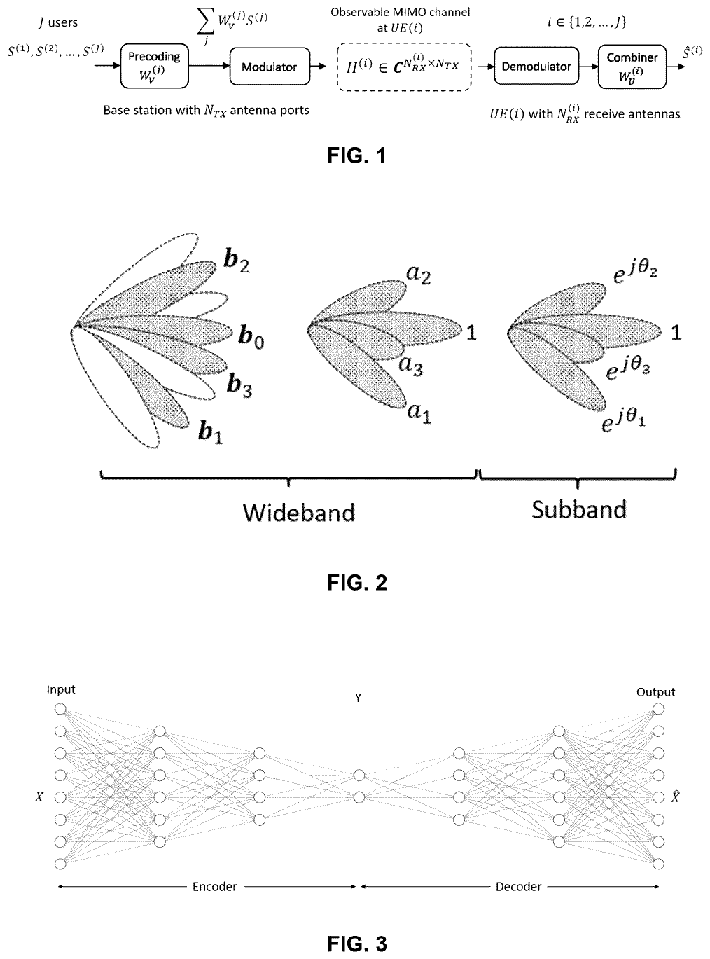

### DETAILED DESCRIPTION

In the following, concepts in accordance with exemplary embodiments of the present disclosure will be explained in more detail and with reference to the accompanying drawings. The illustrated embodiments relate to control of wireless communication in a wireless communication network, in particular to control of uplink signaling from a wireless device to a node of the wireless communication network. The wireless communication network may for example be a cellular network, e.g., as specified by 3GPP. The wireless communication may then for example be based on the NR technology, the LTE technology, or a future 6G (6th Generation) technology. However, the concepts could also be applied in other types of wireless communication network, e.g., based on a WLAN (Wireless Local Area Network) technology.

As used herein, the term “wireless device” (WD) refers to a device capable, configured, arranged, and/or operable to communicate wirelessly with network nodes and/or other WDs. Unless otherwise noted, the term WD may be used interchangeably herein with UE. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a Voice over IP (VoIP) phone, a wireless local loop phone, a desktop computer, a Personal Digital Assistant (PDA), a wireless camera, a gaming console or device, a music storage device, a playback appliance, a wearable terminal device, a wireless endpoint, a mobile station, a tablet, a laptop, Laptop Embedded Equipment (LEE), Laptop Mounted Equipment (LME), a smart device, a wireless Customer Premise Equipment (CPE), a vehicle mounted wireless terminal device, a connected vehicle, etc. In some examples, in an Internet of Things (IoT) scenario, a WD may also represent a machine or other device that performs monitoring and/or measurements, and transmits the results of such monitoring and/or measurements to another WD and/or a network node. The WD may in this case be a Machine-to-Machine (M2M) device, which may in a 3GPP context be referred to as a Machine-Type Communication (MTC) device. As one particular example, the WD may be a UE implementing the 3GPP Narrowband IoT (NB-IoT) standard. Particular examples of such machines or devices are sensors, metering devices such as power meters, industrial machinery, home or personal appliances (e.g., refrigerators, televisions, etc.), or personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

In the illustrated concepts, AI (artificial intelligence) based encoding and decoding of uplink control signaling from a wireless device is applied, i.e., an ML model is used for efficiently encoding and decoding the uplink control signaling. The uplink control signaling can for example include CSI, beam management information, location information, or the like. The ML model may for example implement an AE based on a dual-sided architecture as explained in connection with FIG. 3. Specifically, it is assumed that the ML model is assumed to include an encoder part located at the UE and a decoder part located at a node of the wireless communication network, typically at a base station that receives the uplink control signaling. In the illustrated concepts, the base station may provide capability information indicating ML models that are supported by the base station, e.g., in terms of a list of identifiers (IDs) of ML models supported by the base station. In the following, this capability of the base station (BS) will also be denoted as “BS capability information”. In some scenarios, the base station may broadcast the BS capability information in system information of a cell, e.g., on a PBCH (Phsyical Broadcast Channel) of the cell. In such cases, the BS capability information may for example be included in an MIB (Master Information Block) or in an SIB (System Information Block). However, other types of control data may also be used for conveying the BS capability information, e.g., a message of handover control signaling or other connection control signaling.

When the UE receives the BS capability information, it can take into account the ML models supported by the base station when reporting its own capabilities to the base station. In the following, information indicating the capabilities of the UE will also be denoted as “UE capability information”. The UE capability information reported by the UE may identify ML models supported by the UE, which are selected based on the BS capability information. Specifically, the UE capability information may indicate a selection from the ML models supported by the base station, which is also supported by the UE. Hence, there is no need for the UE to report a supported ML model if this ML model is not supported by the base station. In this way, overhead and complexity of capability signaling from the UE to the base station can be reduced. In some cases, the UE capability information reported by the UE may indicate a final selection of an ML model which will be applied by the UE for encoding the uplink control signaling. In other cases, the UE capability information reported by the UE may indicate a pre-selection of ML models, and the ML model to be applied by the UE may be selected by the base station. Such selection by the base station may then be indicated in further control signaling from the base station to the UE.

When considering the above-mention application scenario of a dual sided AE, the capability signaling of the illustrated concepts is beneficial because it allows for efficiently taking into account that the ML models are dual sided, with an encoder part at the UE and a decoder part at the base station, with both parts typically being jointly trained. Accordingly, an ML model with matching parts at the base station and the UE can be selected in an efficient manner. Reporting of ML models in the UE capability information which cannot be paired with the base station can be avoided. If the BS capability information is broadcasted, a single broadcast message may be sufficient to inform all UEs in the cell about the ML models supported by the base station. Here, indicating a large set of supported ML models is beneficial, because different UEs may support different ML models.

Accordingly, in the illustrated concepts the network side, in particular the base station, may provide control data, e.g., a broadcast MIB or SIB or a handover control message which indicates a set of network side capabilities to support a certain feature, in particular concerning dual sided AI/ML based encoding and decoding of uplink control signaling (set A). The UE may then receive the control data, compare the indicated capabilities with its own set of capabilities for the same feature (set B) and then report back to the network side the intersection of set A and set B.

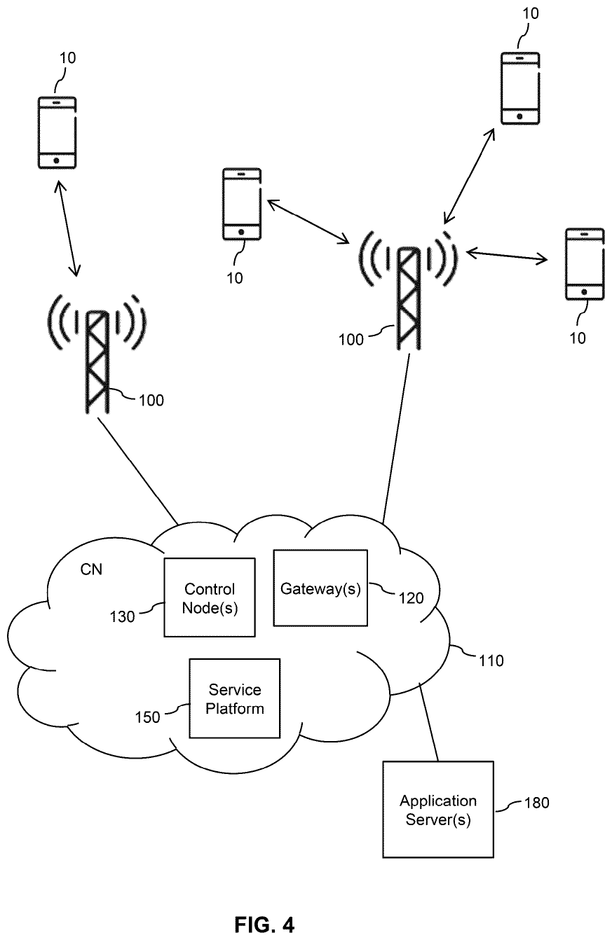

FIG. 4 illustrates exemplary structures of the communication network, which in the illustrated example is assumed to be a wireless communication network as specified by 3GPP. In particular, FIG. 4 shows multiple UEs 10 which are served by base stations 100 of the wireless communication network. Here, it is noted that the base stations 100 may each serve a number of cells within the coverage area of the wireless communication network. The base stations 100 may for example each correspond to a gNB of the NR technology or to an eNB of the LTE technology. The base stations 100 may be regarded as being part of an RAN (Radio Access Network) of the wireless communication network and may thus also be denoted as access node. Further, FIG. 4 schematically illustrates a CN (Core Network) 110 of the wireless communication network. In FIG. 4, the CN 110 is illustrated as including one or more gateways 120 and one or more control node(s) 130. The gateway 120 may be responsible for handling user plane traffic of the UEs 10, e.g., by forwarding user plane data traffic from a UE 10 to a network destination or by forwarding user plane data traffic from a network source to a UE 10. Here, the network destination may correspond to another UE 10, to an internal node of the wireless communication network, or to an external node which is connected to the wireless communication network. Similarly, the network source may correspond to another UE 10, to an internal node of the wireless communication network, or to an external node which is connected to the wireless communication network. The control node(s) 130 may be used for controlling the user data traffic, e.g., by providing control data to the base stations 100, the gateway 120, and/or to the UE 10.

As illustrated by double-headed arrows, the base station 100 may send downlink transmissions to the UEs, and the UEs may send uplink transmissions to the base stations 100. The downlink transmissions and uplink transmissions may be used to provide various kinds of services to the UEs, e.g., a voice service, a multimedia service, or a data service. Such services may be hosted in the CN 110, e.g., by a corresponding network node. By way of example, FIG. 4 illustrates a service platform 150 provided in the CN 110. Further, such services may be hosted externally, e.g., by an AF (application function) connected to the CN 110. By way of example, FIG. 4 illustrates one or more application servers 180 connected to the CN 110. The application server(s) 180 could for example connect through the Internet or some other wide area communication network to the CN 110. The service platform 150 may be based on a server or a cloud computing system and be hosted by one or more host computers. Similarly, the application server(s) 180 may be based on a server or a cloud computing system and be hosted by one or more host computers. The application server(s) 160 may include or be associated with one or more AFs that enable interaction with the CN 110 to provide one or more services to the UEs 10, corresponding to one or more applications. These services or applications may generate the user plane data traffic conveyed by the downlink transmissions and/or the uplink transmissions between the base station 100 and the respective UE 10. Accordingly, the application server(s) 180 may include or correspond to the above-mentioned network destination and/or network source for the user data traffic. In the respective UE 10, such service may be based on an application (or shortly “app”) which is executed on the UE 10. Such application may be pre-installed or installed by the user. Such application may generate at least a part of the user plane traffic between the UE 10 and the base station 100.

In the illustrated concepts, for at least some of the UEs 10 illustrated in FIG. 4, uplink control signaling to the base station 100 may be based on encoding and decoding using an ML model, in particular an AE having an dual-sided architecture with an encoder part at the UE 10 and a decoder part at the base station 100. In this context, the capability signaling of the illustrated concepts may contribute to an efficient selection of the ML model(s) to be applied for the encoding and decoding of the uplink control signaling. The uplink control signaling may for example convey beam management information, CSI, and/or location information.

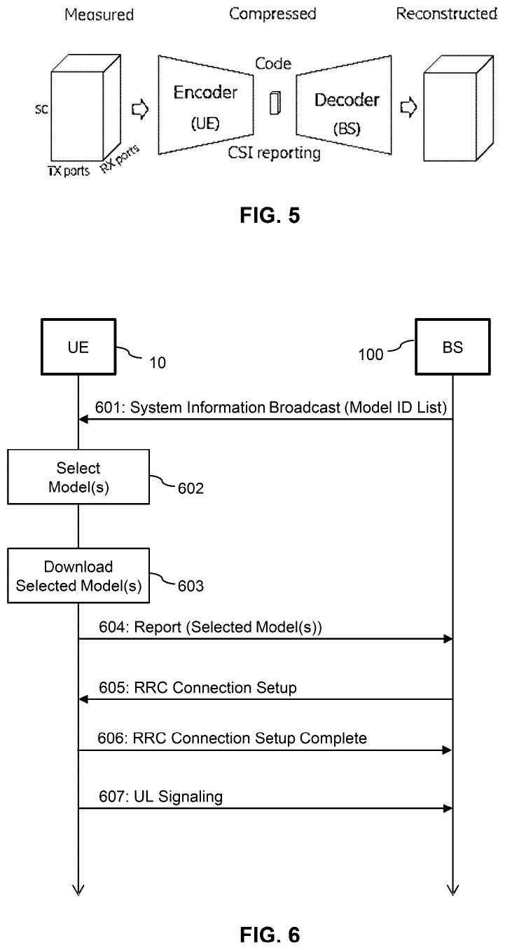

FIG. 5 schematically illustrates how an AE selected based on the illustrated concepts can be applied to controlling MIMO operation, e.g., MU-MIMO operation, of a UE and a base station (BS), e.g., one of the UEs 10 and the base station 100 as illustrated in FIG. 4. The input to the encoder on the UE side includes CSI representing the MIMO channel estimated over several subcarriers (sc), for multiple transmit (TX) ports and receive (RX) ports. For CSI compression, the encoder is implemented in the UE, whereas the decoder is implemented in the base station. The proper selection of the AE allows for efficiently compressing the CSI. Accordingly, CSI feedback can be provided with both high resolution and low uplink overhead. Similar AE-based compression can also be achieved for other types of uplink control signaling, e.g., beam management information or location information.

A list of ML model IDs list may added to system information broadcasted by the base station 100, e.g., as part of cell configuration parameters in an SIB. Based on the broadcasted list of ML model IDs, the UEs 10 that intend to register to the cell will be able to check whether there is a suitable ML model, i.e. whether the base station supports any ML model that matches the ML models supported by the UE, and select such suitable ML model(s). Typically, such matching ML model will include an encoder part and a decoder part that have been jointly trained. Then the UE 10 may then include a list of the selected ML model IDs into UE capability information reported to the base station 100 during connection set up. In some cases, if UE determines that the base station 100 supports one or more ML models currently not supported by the UE 10, the UE 10 can download the model from a network server before the connection set up. In some cases, the UE 10 may report one Model ID per type of uplink control signaling to be encoded/decoded, e.g., one ML model for CSI, one ML model for beam management, one ML model for location information, etc. Accordingly, it is also possible that the UE 10 applies multiple ML models in parallel. In some cases, the UE 10 could also report some or more of the ML model IDs which are not supported by the UE 10. Accordingly, the support of ML models by the UE 10 can be indicated in terms of a positive selection of supported ML models and/or in terms of a negative selection of non-supported ML models.

In the following, the illustrated concepts will be explained in more detail by referring to exemplary processes involving ML-based encoding and decoding of uplink control signaling. In these examples, it is assumed that the encoder part and decoder part of multiple ML models have already been trained jointly, for example using a bi-lateral development domain setup between base station and UE or chipset vendors. A corresponding ID is assigned to each pair of such trained ML models. For example, an AE with encoder part and decoder part may have a UE model ID and a BS model ID, or a model pair ID. In some scenarios, it may also occur that one BS model ID can be paired with, i.e., perform well with, multiple different UE model IDs or vice versa. Hence, the “model ID” could also be generalized to a set of model ID's or can could represent a set of models including “version IDs” which identify different versions of the same model, e.g., versions obtained by updating through further training. If a particular pair of ML models on the UE side an base station side provides good performance in encoding and decoding the uplink control signaling, the pair of ML models can be classified as “matching”. As mentioned above, such matching may be a result of joint training of the ML models. However, such good performance may also occur for pairs of ML models which were not jointly trained. As mentioned above, initially the base station may broadcast or otherwise provide BS capability information indicating the ML models supported by the base station to the UE(s), e.g., in terms of a list of model IDs. Based on that information, the UE can decide which ML models it shall report as supported (or non-supported) in the UE capability information sent to the base station, e.g., during connection setup. Hence, there is no need for the UE to report a model ID it supports, but for which the base station does not support a matching ML model.

Moreover, the UE may use the BS capability information to trigger downloads of certain ML models: If the BS capability information indicates that the base station supports a certain model ID, the UE may download the corresponding ML model from a server. Such download may be performed without explicit knowledge of the base station or CN of the wireless communication network, i.e., “over the top”. When the UE has installed the new ML model, it can send a report to the base station that it supports a new model ID, which would then also be supported by the base station.

As the download and installation of a new ML model may take some time, the UE may already have reported the currently supported ML models to the base station. Later, after the download and installation of the new ML model, the UE may request the base station to schedule the UE with an uplink transmission to allow the UE to update its capability, i.e., to inform the base station by new UE capability information that it now support a new model ID. The base station can then choose to reconfigure the uplink control signaling from the UE to use the new ML model.

In other scenarios, the UE may report to the base station that it does not currently support a certain ML model (identified by a model ID) but will commence to download it for later use. There may be a certain maximum time allowed for such download. For example, the network can assume that the ML model has been downloaded after a certain time interval. The time interval can be predefined or configurable. After expiry of the time interval, the base station can then attempt to configure the UE for uplink control signaling using the newly installed ML model.

There may also be the case of a “blank” UEs, i.e., when the UE has no downloaded ML models and first reads the BS capability information, then downloads a matching ML model, and then reports the UE capability information indicating the support of the matching ML model to the base station.

In some cases, the BS capability information indicating the supported ML models can also be supplemented with additional information, e.g., indications of frequency bands or frequency ranges in which a certain model ID is supported. For example, the base station could support usage of ML-based encoding and decoding or usage of a certain ML model only in some frequency band, and such selective support may be indicated in the BS capability information.

In some case, the BS capability information could also indicate that the base station does not support ML-based encoding and decoding, so that there is no need for the UE to report related capabilities in the UE capability information. In some cases, the base station could indicate such limitation of the support of ML-based encoding and decoding with respect to certain types of uplink control signaling, e.g., by indicating that ML-based encoding and decoding is not supported for CSI, not supported for beam management information, or not supported for location information.

FIG. 6 schematically illustrates an example of processes where the capability signaling of the illustrated concepts is used when setting up a connection between a UE 10 and a base station 100. The UE 10 and the base station 100 may for example correspond to one of the base stations 100 and one of the UEs 10 as illustrated in FIG. 4.

In the example of FIG. 6, the base station 100 broadcasts system information 601. The system information includes a model ID list indicating ML models supported by the base station 100. The model ID list in particular indicates supported decoders on the base station side. The model ID list may indicate the supported ML models per type of uplink control signaling, e.g., whether the ML model is supported for CSI, for beam management, for location information. In some cases, the system information 601 may include such model ID list per band, per band group, or per frequency range. The model ID list(s) may be included in an existing SIB, e.g., in a corresponding information element added to an existing SIB. Alternatively, the model ID list could be included in a dedicated SIB, e.g., used for indicating ML related information.

Assuming that the UE 10 decided to camp on a cell served by the base station 100, the UE 10 receives the system information 601 and reads the included model ID list(s). Based on this information, the UE 10 can check whether or not it can support one or more of the indicated ML models, i.e., select corresponding ML models supported by the UE 10, as indicated by block 602. This selection may be accomplished per type of uplink control signaling. In some cases, the UE 10 may also select an ML model which is not yet supported by the UE 10 and trigger download of such ML model from a server, as indicated by block 603.

When initiating connection setup with the base station 100, the UE 10 then sends a report 604 of the selected ML models to the base station 100. For example, the report 604 may identify the ML models that are supported by the UE 10 (including the ML models optionally downloaded at block 603) in terms of one or more model ID lists. The model ID list(s) may indicate the supported ML models per type of uplink control signaling, e.g., whether the ML model is supported for CSI, for beam management, for location information. In some cases, the report 604 may include such model ID list per band, per band group, or per frequency range. The report 604 may for example correspond to or be part of a UE capability report message. It is noted that it may occur that the UE 10 does not support the ML-based encoding and decoding for all the types of uplink control signaling where it is supported by the base station, and such limitation may also be indicated in the report 604.

As further illustrated, the base station 100 sends an RRC (Radio Resource Control) connection setup message 605 to the UE 10, and the UE responds with an RRC connection setup complete message 606 to configure the connection between the UE 10 and the base station 100. The RRC connection setup message 605 may indicate the ML model(s) to be applied by the UE 10 when sending uplink control signaling 607 to the base station 100. Alternatively, the UE 10 may indicate in the RRC connection setup message 606 which of the supported ML models it will apply when sending uplink control signaling 607.

It is noted that the processes of FIG. 6 may include further messages which, for the sake of a better overview, have not been illustrated.

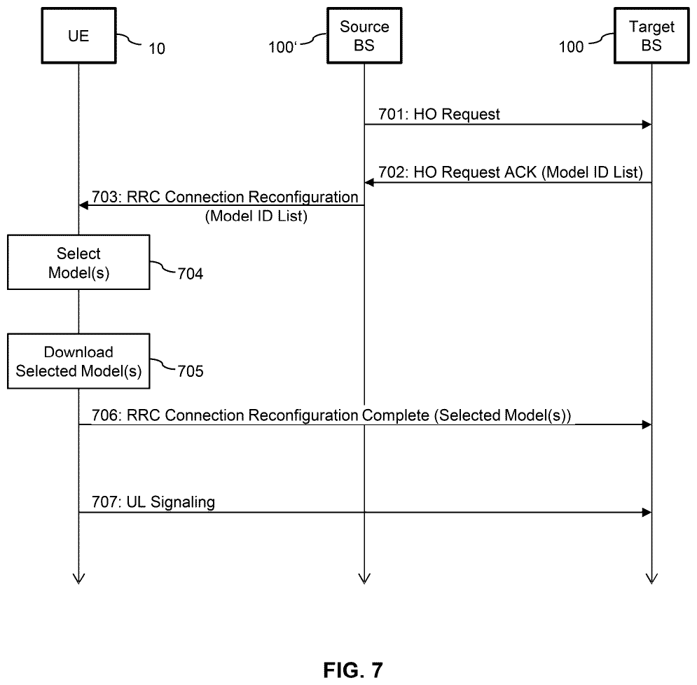

FIG. 7 schematically illustrates an example of processes where the capability signaling of the illustrated concepts is used in a handover (HO) of a UE 10 from a source base station 100′ to a target base station 100. The UE 10 and the base stations 100, 100′ may for example correspond to the base stations 100 and one of the UEs 10 as illustrated in FIG. 4. In a handover scenario like illustrated in FIG. 7, a list of ML model IDs supported by the target cell (corresponding to the target base station 100) is provided to the UE 10 during the handover procedure. In particular, the source cell (corresponding to the source base station 100′) and the target cell may exchange information related to the ML models supported by the target cell.

In the example of FIG. 7, the handover of the UE 10 is initiated by a Handover Request 701 from the source base station 100′ to the target base station 100. The target base station 100 acknowledges the requested handover by sending a Handover Request Acknowledgement (HO Request ACK) 702 to the source base station 100′. The Handover Request Acknowledgement 702 includes a model ID list indicating ML models supported by the target base station 100. The model ID list may indicate the supported ML models per type of uplink control signaling, e.g., whether the ML model is supported for CSI, for beam management, for location information. In some cases, the Handover Request Acknowledgement 702 may include such model ID list per band, per band group, or per frequency range. The model ID list(s) may be included in a corresponding information element of the Handover Request Acknowledgement 702.

The source base station 100′ then forwards the model ID list(s) in an RRC Connection Reconfiguration message 703 to the UE 10. The UE 10 receives the RRC Connection Reconfiguration message 703 and reads the included model ID list(s). Based on this information, the UE 10 can check whether or not it can support one or more of the indicated ML models, i.e., select corresponding ML models supported by the UE 10, as indicated by block 704. This selection may be accomplished per type of uplink control signaling. In some cases, the UE 10 may also select an ML model which is not yet supported by the UE 10 and trigger download of such ML model from a server, as indicated by block 705.

The UE 10 then sends an RRC Connection Reconfiguration Complete message 706 to the target base station 100. The RRC Connection Reconfiguration Complete message 706 indicates the selected ML models of block 704, e.g., in a corresponding information element of the RRC Connection Reconfiguration Complete message 706. The RRC Connection Reconfiguration Complete message 706 may identify the ML models that are supported by the UE 10 (including the ML models optionally downloaded at block 603) in terms of one or more model ID lists. The model ID list(s) may indicate the supported ML models per type of uplink control signaling, e.g., whether the ML model is supported for CSI, for beam management, for location information. In some cases, the RRC Connection Reconfiguration Complete message 706 may include such model ID list per band, per band group, or per frequency range. It is noted that it may occur that the UE 10 does not support the ML-based encoding and decoding for all the types of uplink control signaling where it is supported by the base station, and such limitation may also be indicated in the RRC Connection Reconfiguration Complete message 706.

As further illustrated, the UE 10 may then send uplink control signaling 707 based on at least of the supported ML models. It is noted that the processes of FIG. 7 may include further messages which, for the sake of a better overview, have not been illustrated. For example, such messages could be used to further negotiate selection of one or modes from a set of ML models indicated as being supported by the UE 10 in the RRC Connection Reconfiguration Complete message 706.

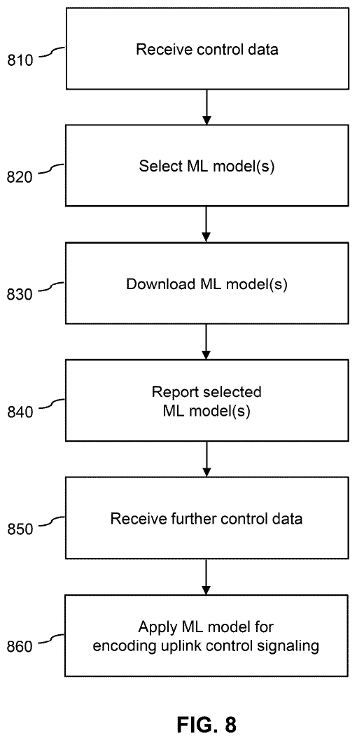

FIG. 8 shows a flowchart for illustrating a method, which may be utilized for implementing the illustrated concepts. The method of FIG. 8 may be used for implementing the illustrated concepts in wireless device for operation in a wireless communication network, e.g., corresponding to one of the above-mentioned UEs 10.

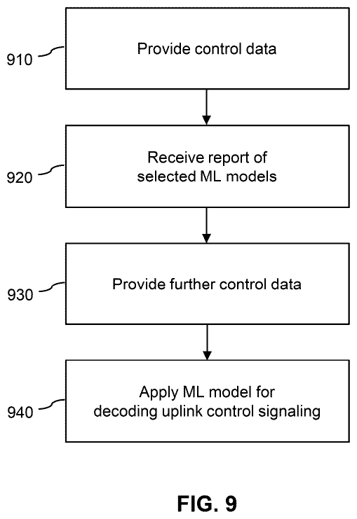

If a processor-based implementation of the wireless device is used, at least some of the steps of the method of FIG. 9 may be performed and/or controlled by one or more processors of the wireless device. Such wireless device may also include a memory storing program code for implementing at least some of the below described functionalities or steps of the method of FIG. 9.

At step 910, the node provides control data to one or more wireless devices, e.g., corresponding to one or more of the above-mentioned UEs 10. The control data indicate a set of one or more supported ML models for encoding and decoding of uplink control signaling from the wireless device to the node. The control data may for example indicate the supported ML models in terms of a list of model IDs. The node may send the control data in a wireless transmission. The wireless transmission can be a broadcast transmission, e.g., as explained for the system information 601 of FIG. 6. In some scenarios, the wireless device may receive the control data in a wireless transmission from a second node of the wireless communication network. For example, this can be the case in a handover scenario. The control data could then control a handover of the wireless device from the second node to the first node.

The uplink control signaling may include CSI. In addition or as an alternative, the uplink control signaling may include beam management information. In addition or as an alternative, the uplink control signaling may include location information. The ML models may be neural network based and may correspond to an AE having a dual-sided architecture having an encoder part at the wireless device and a decode part at the base station, e.g., as illustrated in FIG. 3.

At step 820, the wireless device selects one or more of the ML models from the set. The selection may be based on matching of ML models in the set to ML models supported by the wireless device.

At step 830, in response to the selection of step 820, the wireless device may download at least one of the ML models selected at step 820. This may for example be done in response to the control data indicating that the base station supports the ML model, but the ML model is not yet supported by the wireless device. The wireless device may download the at least one ML model from a server which is accessible through the wireless communication network.

At step 840, the wireless device may report the selected one or more ML models to the first node. In some scenarios, the wireless device may select multiple ML models from the set and report the multiple selected ML models to the first node. The reporting of step 840 may for example be accomplished by a capability information message sent during setup of a connection between the wireless device and the base station, e.g., as explained for the report 604 of FIG. 6. Further, the reporting of step 840 could be accomplished by a message of a handover procedure, e.g., as explained for the RRC Connection Reconfiguration Complete message 706 of FIG. 7.

At step 850, the wireless device may receive further control data. If at steps 830 and 840 the wireless device selected multiple ML models from the set and reported the multiple selected ML models to the first node, the further control data may indicate at least one of the reported ML models which is to be applied by the wireless device for encoding the uplink control signaling. Such further control data could for example be conveyed by the RRC Connection Setup message 605 of FIG. 6 or by a further message following the RRC Connection Reconfiguration message 706 of FIG. 7.

At step 860, the wireless device encodes uplink control signaling from the wireless device to the first node. This encoding may be accomplished based on at least one of the one or more ML models selected at step 820, and optionally downloaded at step 830.

FIG. 9 shows a flowchart for illustrating a method, which may be utilized for implementing the illustrated concepts. The method of FIG. 9 may be used for implementing the illustrated concepts in a node of the wireless communication network, e.g., corresponding to one of the above-mentioned base stations 100.

If a processor-based implementation of the node is used, at least some of the steps of the method of FIG. 9 may be performed and/or controlled by one or more processors of the node. Such node may also include a memory storing program code for implementing at least some of the below described functionalities or steps of the method of FIG. 9.

At step 910, the wireless device receives control data provided by a first node of the wireless communication network. The control data indicate a set of one or more supported ML models for encoding and decoding of uplink control signaling from the wireless device to the first node. The control data may for example indicate the supported ML models in terms of a list of model IDs. The wireless device may receive the control data in a wireless transmission from the first node. The wireless transmission from the first node can be a broadcast transmission, e.g., as explained for the system information 601 of FIG. 6. In some scenarios, the node may send the control data via a further node of the wireless communication network. For example, this can be the case in a handover scenario. The control data could then control a handover of the wireless device from the further node to the node.

The uplink control signaling may include CSI. In addition or as an alternative, the uplink control signaling may include beam management information. In addition or as an alternative, the uplink control signaling may include location information. The ML models may be neural network based and may correspond to an AE having a dual-sided architecture having an encoder part at the wireless device and a decode part at the base station, e.g., as illustrated in FIG. 3.

At step 920, the node may receive a report from at least one of the wireless devices. The report may indicate one or more ML models selected from the set. In some scenarios, the report may indicate multiple selected ML models from the set. The report of step 920 may for example be received in a capability information message sent during setup of a connection between the wireless device and the base station, e.g., as explained for the report 604 of FIG. 6. Further, the report of step 920 could be received in a message of a handover procedure, e.g., as explained for the RRC Connection Reconfiguration Complete message 706 of FIG. 7.

At step 930, the node may provide further control data to at least one of the one or more wireless devices. If at step 930 the wireless device reported multiple ML models selected from the set, the further control data may indicate at least one of the reported ML models which is to be applied by the wireless device for encoding the uplink control signaling. Such further control data could for example be conveyed by the RRC Connection Setup message 605 of FIG. 6 or by a further message following the RRC Connection Reconfiguration message 706 of FIG. 7.

At step 940, the node decodes uplink control signaling from at least one of the wireless devices. This decoding may be accomplished based on at least one of the one or more ML models indicated by the control data of step 910.

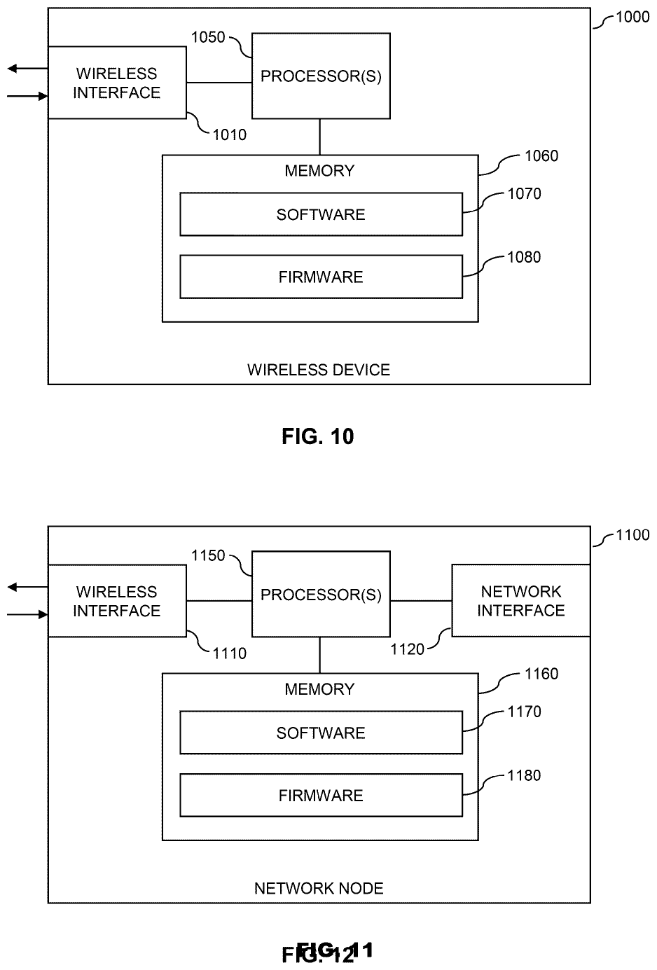

FIG. 10 schematically illustrates a processor-based implementation of a wireless device 1000 for operation in a wireless communication network, which may be used for implementing the above-described concepts. For example, the structures as illustrated in FIG. 10 may be used for implementing the concepts in one or more of the above-mentioned UEs 10.

As illustrated, the wireless device 1000 may include a wireless interface 1010. The wireless interface 1010 may be used for wireless communication with one or more nodes of the wireless communication network, such as the above-mentioned base stations 100.

Further, the wireless device 1000 may include one or more processors 1050 coupled to the wireless interface 1010 and a memory 1060 coupled to the processor(s) 1050. By way of example, the wireless interface 1010, the processor(s) 1050, and the memory 1060 could be coupled by one or more internal bus systems of the wireless device 1000. The memory 1060 may include a read-only memory (ROM), e.g., a flash ROM, a random-access memory (RAM), e.g., a dynamic RAM (DRAM) or static RAM (SRAM), a mass storage, e.g., a hard disk or solid state disk, or the like. As illustrated, the memory 1060 may include software 1070 and/or firmware 1080. The memory 1060 may include suitably configured program code to be executed by the processor(s) 1050 so as to implement the above-described functionalities for controlling wireless communication, such as explained in connection with FIG. 8.

It is to be understood that the structures as illustrated in FIG. 10 are merely schematic and that the wireless device 1000 may actually include further components which, for the sake of clarity, have not been illustrated, e.g., further interfaces or further processors. Also, it is to be understood that the memory 1060 may include further program code for implementing known functionalities of a UE supporting the NR technology or the LTE technology. According to some embodiments, also a computer program may be provided for implementing functionalities of the wireless device 1000, e.g., in the form of a physical medium storing the program code and/or other data to be stored in the memory 1060 or by making the program code available for download or by streaming.

FIG. 11 schematically illustrates a processor-based implementation of a node 1100 for a wireless communication network, which may be used for implementing the above-described concepts. For example, the structures as illustrated in FIG. 11 may be used for implementing the concepts in one or more of the above-mentioned base stations 100 or similar access nodes.

As illustrated, the node 1100 may include a wireless interface 1110 and a network interface 1120. The wireless interface 1110 may be used for wireless communication with one or more wireless device, such as the above-mentioned UEs 10. The network interface 1120 may be used for communication with one or more other nodes of the wireless communication network, e.g., other access nodes or CN nodes.

Further, the node 1100 may include one or more processors 1150 coupled to the interfaces 1110, 1120 and a memory 1160 coupled to the processor(s) 1150. By way of example, the interfaces 1110, 1120, the processor(s) 1150, and the memory 1160 could be coupled by one or more internal bus systems of the node 1100. The memory 1160 may include a ROM, e.g., a flash ROM, a RAM, e.g., a DRAM or SRAM, a mass storage, e.g., a hard disk or solid state disk, or the like. As illustrated, the memory 1160 may include software 1170 and/or firmware 1180. The memory 1160 may include suitably configured program code to be executed by the processor(s) 1150 so as to implement the above-described functionalities for controlling wireless communication, such as explained in connection with FIG. 9.

It is to be understood that the structures as illustrated in FIG. 11 are merely schematic and that the node 1100 may actually include further components which, for the sake of clarity, have not been illustrated, e.g., further interfaces or further processors. Also, it is to be understood that the memory 1160 may include further program code for implementing known functionalities of a gNB of the NR technology, an eNB of the LTE technology, or similar type of access node. According to some embodiments, also a computer program may be provided for implementing functionalities of the node 1100, e.g., in the form of a physical medium storing the program code and/or other data to be stored in the memory 1160 or by making the program code available for download or by streaming.

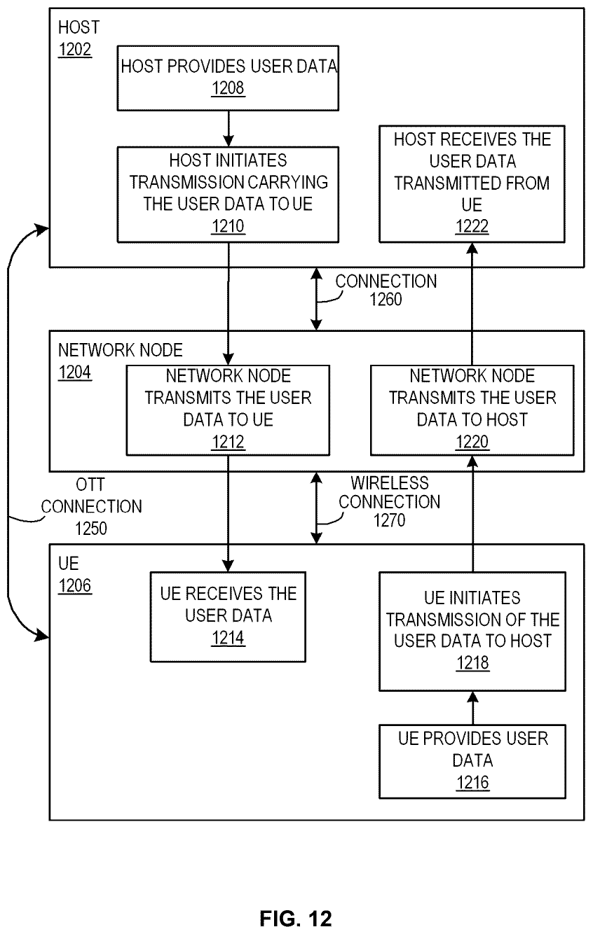

FIG. 12 shows a communication diagram of a host 1202 communicating via a network node 1204 with a UE 1206 over a partially wireless connection in accordance with some embodiments. Example implementations, in accordance with various embodiments, of the UE (such as one of the above-mentioned UEs 10), network node (such as one of the above-mentioned base stations), and host (such as the above-mentioned service platform 150 or application server(s) 180) will now be described with reference to FIG. 12.

Embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 110 of FIG. 4) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

The illustrated concepts may help to improve, performance of OTT services provided to the UE 1206 using the OTT connection 1250, in which the wireless connection 1270 forms the last segment. More precisely, the teachings of these embodiments may improve the efficiency of uplink control signaling and thereby allow for more precisely and efficiently control data transfers on the last segment of the OTT connection 1250.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

As can be seen, the concepts as described above may be used for efficiently managing usage of ML-based encoding and decoding of uplink control signaling, e.g., by an AE. In particular, by the capability signaling of the illustrated concepts, the usage of the ML-based encoding and decoding can be managed with low overhead and complexity cost.

In the illustrated concepts, usage of AE-based uplink control signaling may provide several benefits: If the uplink control signaling conveys CSI, AEs can efficiently include non-linear transformations that improve compression performance and, therefore, improve MU-MIMO performance for the same uplink overhead. Further, AEs can be trained to exploit long-term redundancies in the propagation environment and/or site, e.g., antenna configuration, for compression purposes. For example, a particular AE does not need to work well for all possible deployments. Improved compression performance is obtained by learning which channel inputs need to (and/or which don't need to) be reliably reconstructed at the base-station. Further, AEs can be trained to compensate for antenna array irregularities; for example, non-uniformly spaced antenna elements and non-half wavelength element spacing. Further, AEs can be updated, e.g., via transfer learning and training, to compensate for failing hardware as the product ages.

It is to be understood that the examples and embodiments as explained above are merely illustrative and susceptible to various modifications. For example, the illustrated concepts may be applied in connection with various kinds of communication technologies, without limitation to wireless technologies or a technology specified by 3GPP. Further, the illustrated concepts may be applied for ML-based encoding and decoding of various kinds of signaling, without limitation to the above-mentioned examples of CSI, beam management information, or location information conveyed by uplink control signaling. Moreover, it is to be understood that the above concepts may be implemented by using correspondingly designed software to be executed by one or more processors of an existing device or apparatus, or by using dedicated device hardware. Further, it should be noted that the illustrated nodes, apparatuses or devices may each be implemented as a single device or as a system of multiple interacting devices or modules, e.g., based on virtualized cloud components.

1. A method of controlling wireless communication in a wireless communication network, the method comprising:
a wireless device receiving control data provided by a first node of the wireless communication network, the control data indicating a set of one or more supported machine learning, ML, models for encoding and decoding of uplink control signaling from the wireless device to the first node;
the wireless device selecting one or more of the ML models from the set; and
based on at least one of the one or more selected ML models, the wireless device encoding uplink control signaling from the wireless device to the first node.

2. The method according to claim 1, comprising:
the wireless device reporting the selected one or more ML models to the first node.

3. The method according to claim 2, comprising:
the wireless device selecting multiple ML models from the set and reporting the ML models to the first node; and
the wireless device receiving further control data from the first node, the further control data indicating at least one of the reported ML models to be applied by the wireless device for encoding the uplink control signaling.

4. The method according to claim 1,
wherein the wireless device receives the control data in a wireless transmission from the first node.

5. The method according to claim 4,
wherein the wireless transmission from the first node is a broadcast transmission.

6. The method according to claim 1,
wherein the wireless device receives the control data in a wireless transmission from a second node of the wireless communication network.

7. The method according to claim 6,
wherein the control data controls a handover of the wireless device from the second node to the first node.

8. The method according to claim 1, comprising:
in response to selecting the one or more ML models from the set, the wireless device downloading at least one of the one or more selected ML models.

9. The method according to claim 1,
wherein the uplink control signaling comprises channel state information.

10. The method according to claim 1,
wherein the uplink control signaling comprises beam management information.

11. The method according to claim 1,
wherein the uplink control signaling comprises location information.

12. The method according to claim 1,
wherein the ML models are neural network based.

13. A method of controlling wireless communication in a wireless communication network, the method comprising:
a node of the wireless communication network providing control data to one or more wireless devices, the control data indicating a set of one or more supported machine-learning, ML, models for encoding and decoding of uplink control signaling from the wireless device to the node; and
using at least one ML model selected from the set, the node decoding uplink control signaling from at least one of the one or more wireless devices.

14. (canceled)

15. The method according to claim 13, comprising:
the node receiving a report from the at least one wireless device, the report indicating multiple ML models from the list;
the node selecting at least one ML model from the reported ML models; and
the node providing further control data to the at least one wireless device, the further control data indicating the selected at least one of the reported ML models to be applied by the wireless device for encoding the uplink control signaling.

16-17. (canceled)

18. The method according to claim 13,
wherein the node provides the control data via a further node of the wireless communication network.

19. The method according to claim 18,
wherein the control data controls a handover of the wireless device from the further node to the node.

20-21. (canceled)

22. The method according to claim 13,
wherein the uplink control signaling comprises location information.

23. (canceled)

24. A wireless device for operation in a wireless communication network, the wireless device being configured to:
receive control data provided by a first node of the wireless communication network, the control data indicating a set of one or more supported machine learning, ML, models for encoding and decoding of uplink control signaling from the wireless device to the first node,
select one or more of the ML models from the set; and
based on at least one of the selected one or more ML models, encode uplink control signaling from the wireless device to the first node.

25-29. (canceled)

30. A non-transitory computer-readable medium comprising program code to be executed by at least one processor of a wireless device operating in a wireless communication network, whereby execution of the program code causes the wireless device to perform the method according to claim 1.

31. A non-transitory computer-readable medium comprising program code to be executed by at least one processor of a node of a wireless communication network, whereby execution of the program code causes the node to perform the method according to claim 13.
